(19) United States
(12) Patent Application Publication
(10) Pub. No.: US 2024/0280028 A1
(43) Pub. Date: Aug. 22, 2024

(54) TURBINE ENGINE WITH A BLADE ASSEMBLY HAVING A DOVETAIL

(71) Applicant: GENERAL ELECTRIC COMPANY, Schenectady, NY (US)

(72) Inventors: Clive Andrew Morgan, Laurens, SC (US); Zachary Allen Hase, Miamisburg, OH (US); Brian Lee DeVilbiss, West Chester, OH (US); Daniel Endecott Osgood, Loveland, OH (US)

(21) Appl. No.: 18/171,836

(22) Filed: Feb. 21, 2023

(51) Int. Cl. F01D 5/30; F02C 3/04

(52) U.S. Cl. CPC F01D 5/3007; F02C 3/04

(57) ABSTRACT

A turbine engine includes an engine core extending along an engine centerline and includes a compressor section, a combustor, and a turbine section in serial flow arrangement. A set of blades are circumferentially arranged in the turbine section and the compressor section. A set of dovetails mounts the set of blades to a disk, rotated about the engine centerline. Each dovetail can include a set of lobes defining complementary recesses, collectively defining a neck for mounting to the disk.

### TECHNICAL FIELD

The present subject matter relates generally to a blade having a dovetail for a turbine engine, and more specifically to a blade with a dovetail and geometric features.

### BACKGROUND

A gas turbine engine typically includes a turbomachine, with a fan in some implementations. The turbomachine generally includes a compressor, combustor, and turbine in serial flow arrangement. The compressor compresses air which is channeled to the combustor where it is mixed with fuel. The mixture is then ignited for generating hot combustion gases. The combustion gases are channeled to the turbine, which extracts energy from the combustion gases for powering the compressor and fan, if used, as well as for producing useful work to propel an aircraft in flight or to power a load, such as an electrical generator.

During operation of the gas turbine engine, various systems generate a relatively large amount of heat and stress. For example, a substantial amount of heat or stress can be generated during operation of the thrust generating systems, lubrication systems, electric motors and/or generators, hydraulic systems or other systems. A design that mitigates heat loads and/or stresses on an engine component is advantageous.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine, in accordance with an exemplary embodiment of the present disclosure.

FIG. 2 is a schematic cross-sectional view of a turbine section of the gas turbine engine of FIG. 1, in accordance with an exemplary embodiment of the present disclosure.

FIG. 3 is a perspective view of a blade assembly for use in the gas turbine engine of FIG. 1, in accordance with an exemplary embodiment of the present disclosure.

FIG. 4 is a perspective view of an aft face of the blade assembly of FIG. 3, in accordance with an exemplary embodiment of the present disclosure.

FIG. 5 is a bottom view of the blade assembly of FIGS. 3-4, showing a bottom surface having inlet passages and an offset plane, in accordance with an exemplary embodiment of the present disclosure.

FIG. 6 is a cross-sectional view of the blade assembly of FIG. 5 taken along the offset plane and looking in a forward direction, in accordance with an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Aspects of the disclosure generally relate to turbine engine dovetails for turbine engine blades, such as cooled turbine engine blades. Traditional dovetails often include a ‘neck’ or a somewhat variable geometry in order to mount the turbine engine blades to the engine disk. High engine temperatures and operational forces impart large stresses to this ‘neck’. Large stresses contribute to an unexpected or premature part replacement due to deterioration in this ‘neck’ area. Therefore, there is a need for a dovetail with a ‘neck’ area that withstands the large stresses.

Aspects of the disclosure provide for a dovetail with a specific geometry where the dovetail mounts to the disk. Aspects of the disclosure also provide for a dovetail with a specifically defined neck geometry, providing improved performance under engine stresses.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As may be used herein, the terms “first”, “second”, “third”, and “fourth” can be used interchangeably to distinguish one component from another and are not intended to signify location or importance of the individual components.

A “set” or a set of elements as used herein can include any number of said elements, including one.

The terms “forward” and “aft” as may be used herein refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

The term “fluid” can be a gas or a liquid.

The singular forms “a”, “an”, and “the” include plural references unless the context clearly dictates otherwise.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer those two elements are directly connected and in fixed relation to one another. The exemplary drawings are for purposes of illustration only and the dimensions, positions, order and relative sizes reflected in the drawings attached hereto can vary.

As used herein, a “stage” of either the compressor or turbine is a pair of adjacent set of blades and set of vanes, with both sets of the blades and vanes circumferentially arranged about an engine centerline. The blades rotate relative to the engine centerline and, in one example, are mounted to a rotating structure, such as a disk, to affect the rotation. A pair of circumferentially-adjacent vanes in the set of vanes are referred to as a nozzle. In one implementation, the vanes are stationary and mounted to a casing surrounding the set of blades. In another implementation with a counter-rotating engine, the vanes are mounted to a rotating drum surrounding the set of blades. The rotation of the blades creates a flow of air through the vanes/nozzles.

As used herein, “exhaust gas temperature” (denoted “EGT”) refers to a gas temperature in a turbine engine, which can be measured at a location in the turbine under takeoff power conditions during a 5-minute period, in one non-limiting example, or at cruise conditions during flight. In another non-limiting example, the EGT can be measured local to a dovetail as described herein. In yet another non-limiting example, the EGT can be determined at a combustor upstream of a high-pressure turbine.

As used herein, “radial” or “radially” refers to a span-wise direction defined between a blade root and a blade tip. In some implementations, the span-wise direction is non-orthogonal to an engine centerline. In some implementations, the span-wise direction is orthogonal to an engine centerline.

As used herein, the term “stress”, as well as related terms “contour stress”, “stress concentration”, “critical crush stress”, and “stress tangency” or “stress tangency point”, refer to a degree of force imparted to a physical portion or point of the component or dovetail. “Contour stress” refers to a planar, curved, or line-function representation of stress over an area. “Stress concentration” refers to a local position with a relatively larger or greater amount of local force relatively to a nearby or similar position. “Critical crush stress” refers to a force value representing a threshold, where exceeding that threshold results in material crushing or deformation. “Stress tangency” refers to an amount of force defined at a point or line arranged tangent to a relative surface or portion thereof.

As used herein, “load path” refers to a line or directionality upon which a load force is applied and extends through a physical portion of the dovetail. The load path can be represented as the contour stress or stress concentration, where the load path is defined by the contours or concentration having a relatively larger amount of force or stress.

As used herein, “bending moment” refers to the force imparted to a physical portion of the dovetail over a length or area resulting in bending of that physical portion.

The term “blade centroid” as used herein refers to a center of mass of the blade. The “blade centroid” can be used to balance the blade centrifugal forces resulting from engine rotation with bending moments created by the gas stream forces passing along the blade. Deviance from this force balance results in increased blade or disk stresses, as well as reduced component durability requiring additional maintenance.

“LPF” as used herein represents a length of a planar surface of a dovetail arranged at a neck on a radially interior lobe on a first portion of the dovetail. The length is the shortest distance between opposing edges of the planar surface.

“CVX” as used herein represents a length of a portion of a dovetail in combination with a gage pin provided within a recess at a neck of the dovetail. The length is defined between a passage axis defined along an inlet passage extending through the dovetail, and the aft-most axial extent of the gage pin provided within the recess. This can be positioned complementary to the convex portion of the blade, or the suction side thereof.

“N2” as used herein represents a rotational speed for the engine, which is defined by the rotational speed of the particular dovetail within the engine.

“EGT” as used herein represents an engine exhaust gas temperature.

“L” as used herein represents a length of a radius of curvature defined by a curved surface of a dovetail arranged at a neck, where the curved surface is provided in a recess of a neck defined by the dovetail, and partially forms a radially outer lobe.

“CVMN” as used herein represents a length of a portion of a neck defined by a dovetail. The length is defined as the minimum distance between a recess and an inlet passage extending interior of the dovetail. This can be positioned complementary to the concave portion of the blade, or the pressure side thereof.

In certain exemplary embodiments of the present disclosure, a gas turbine engine defining a centerline and a circumferential direction is provided. The gas turbine engine generally includes a rotor assembly and a stator assembly. The rotor assembly and the stator assembly collectively define a substantially annular flow path relative to the centerline of the gas turbine engine. The rotor assembly includes a set of blades. Each blade of the set of blades mounts to a rotor, such as a disk at a dovetail, and the set of blades can be distributed circumferentially about the engine centerline mounted to the disk. It is further contemplated that the set of blades can be any number of blades mounted to the disk. The stator assembly includes a set of vanes. The set of vanes extend between inner and outer bands and are distributed circumferentially about the centerline. The set of vanes also defines a set of nozzles. It is further contemplated that the set of vanes includes a single pair of vanes defining a single nozzle. Rotation of the disk causes the set of blades to produce a fluid flow through the set of nozzles. The number of blades and the number of nozzles for a stage are both contributors to controlling a flow across each blade and through the nozzles.

Dovetails include a neck structure, having a relatively thin portion, compared to the remainder of the dovetail, which slidably inserts into the disk to mount each blade to the rotor. This thin neck structure is susceptible to high local stresses due to the extreme engine operational conditions.

In addition, it can be appreciated that multiple local factors have an effect on dovetail durability in an engine environment. These factors can include a local radius of curvature at the neck, dovetail lobe number and size, or particular sizing of portions of the dovetail, such as lengths including distance between two points, or an axial distance relative to the engine longitudinal extent. These factors need to be balanced against stringent engine efficiency and spacing requirements. Therefore, providing a detailed geometry for the dovetail that reduces or mitigates stresses on the dovetail while being capable of operation within current disk systems is desirable.

The standard practice for solving the problem of improved dovetail durability has been to use increased sizes or stronger material, which combat local stresses. However, such geometry and materials lead to increase costs, system weight, and overall space occupied by the dovetail. This requires a cost-benefit analysis, which reduces overall engine efficiency, or requires redesign of related components to compensate for the larger or stronger materials. In some cases, such a cost-benefit analysis is impractical or impossible. Therefore, a more intuitive solution is needed, with a greater benefit for systems that are used in existing engines, and without requiring redesign of related components.

The inventors' practice has proceeded in the manner of designing a turbine engine with a dovetail for a blade that is suitable for use in existing systems, while reducing, decreasing, or otherwise improving local stresses. The inventors discovered during this practice that by specifying particular dimensions and geometries for portions of the dovetail, such as at the neck area, that these local stresses are reduced. This improvement was realized without requiring increased size or stronger materials, and utilized in existing systems without a redesign or reengineering of related components.

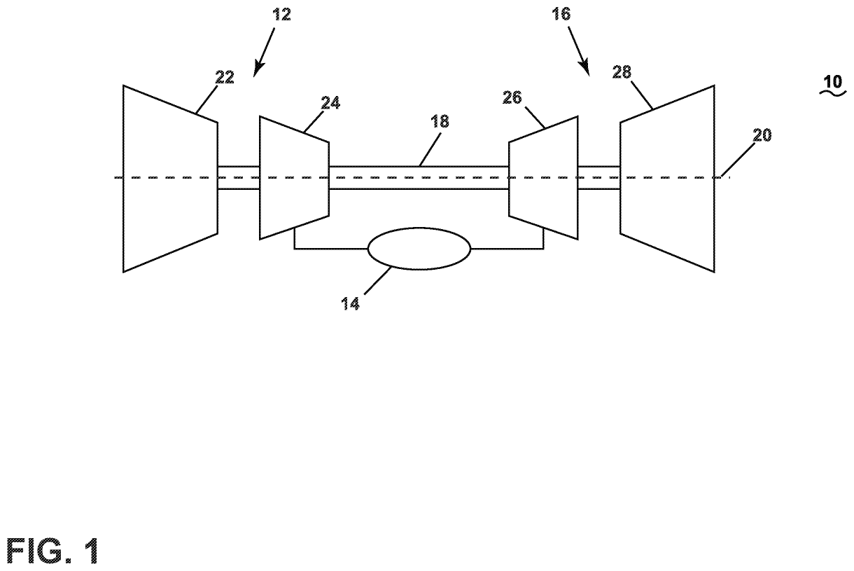

Referring now to the drawings, FIG. 1 is a schematic view of a turbine engine 10. As a non-limiting example, the turbine engine 10 can be used within an aircraft. The turbine engine 10 includes an engine core including, at least, a compressor section 12, a combustor 14, and a turbine section 16. A fan (not shown) provides air to the compressor section 12. A drive shaft 18 rotationally couples the fan, compressor section 12, and turbine section 16, such that rotation of one affects the rotation of the others, and defines a rotational axis or engine centerline 20 for the turbine engine 10.

The compressor section 12 includes a low-pressure (LP) compressor 22 and a high-pressure (HP) compressor 24 serially fluidly coupled to one another. The turbine section 16 includes an HP turbine 26 and a LP turbine 28 serially fluidly coupled to one another. The drive shaft 18 operatively couples the LP compressor 22, the HP compressor 24, the HP turbine 26 and the LP turbine 28 together. In some implementations, the drive shaft 18 includes an LP drive shaft (not illustrated) and an HP drive shaft (not illustrated), where the LP drive shaft couples the LP compressor 22 to the LP turbine 28, and the HP drive shaft couples the HP compressor 24 to the HP turbine 26.

The compressor section 12 includes a plurality of axially spaced stages. Each stage includes a set of circumferentially-spaced rotating blades and a set of circumferentially-spaced stationary vanes. In one configuration, the compressor blades for a stage of the compressor section 12 are mounted to a disk, which is mounted to the drive shaft 18. Each set of blades for a given stage can have its own disk. In one implementation, the vanes of the compressor section 12 are mounted to a casing which extends circumferentially about the turbine engine 10. In a counter-rotating turbine engine, the vanes are mounted to a drum, which is similar to the casing, except the drum rotates in a direction opposite the blades, whereas the casing is stationary. It will be appreciated that the representation of the compressor section 12 is merely schematic and that there can be any number of stages. Further, it is contemplated that there can be any other number of components within the compressor section 12.

Similar to the compressor section 12, the turbine section 16 includes a plurality of axially spaced stages, with each stage having a set of circumferentially-spaced, rotating blades and a set of circumferentially-spaced, stationary vanes. In one configuration, the turbine blades for a stage of the turbine section 16 are mounted to a disk which is mounted to the drive shaft 18. Each set of blades for a given stage can have its own disk. In one implementation, the vanes of the turbine section are mounted to the casing in a circumferential manner. In a counter-rotating turbine engine, the vanes can be mounted to a drum, which is similar to the casing, except the drum rotates in a direction opposite the blades, whereas the casing is stationary. It is noted that there can be any number of blades, vanes and turbine stages as the illustrated turbine section is merely a schematic representation. Further, it is contemplated that there can be any other number of components within the turbine section 16.

The combustor 14 is provided serially between the compressor section 12 and the turbine section 16. The combustor 14 is fluidly coupled to at least a portion of the compressor section 12 and the turbine section 16 such that the combustor 14 at least partially fluidly couples the compressor section 12 to the turbine section 16. As a non-limiting example, the combustor 14 is fluidly coupled to the HP compressor 24 at an upstream end of the combustor 14 and to the HP turbine 26 at a downstream end of the combustor 14.

During operation of the turbine engine 10, ambient or atmospheric air is drawn into the compressor section 12 via the fan, upstream of the compressor section 12, where the air is compressed defining a pressurized air. The pressurized air then flows into the combustor 14 where the pressurized air is mixed with fuel and ignited, thereby generating combustion gases. Some work is extracted from these combustion gases by the HP turbine 26, which drives the HP compressor 24. The combustion gases are discharged into the LP turbine 28, which extracts additional work to drive the LP compressor 22, and the exhaust gas is ultimately discharged from the turbine engine 10 via an exhaust section (not illustrated) downstream of the turbine section 16. The driving of the LP turbine 28 drives the LP spool to rotate the fan and the LP compressor 22. The pressurized airflow and the combustion gases together define a working airflow that flows through the fan, compressor section 12, combustor 14, and turbine section 16 of the turbine engine 10.

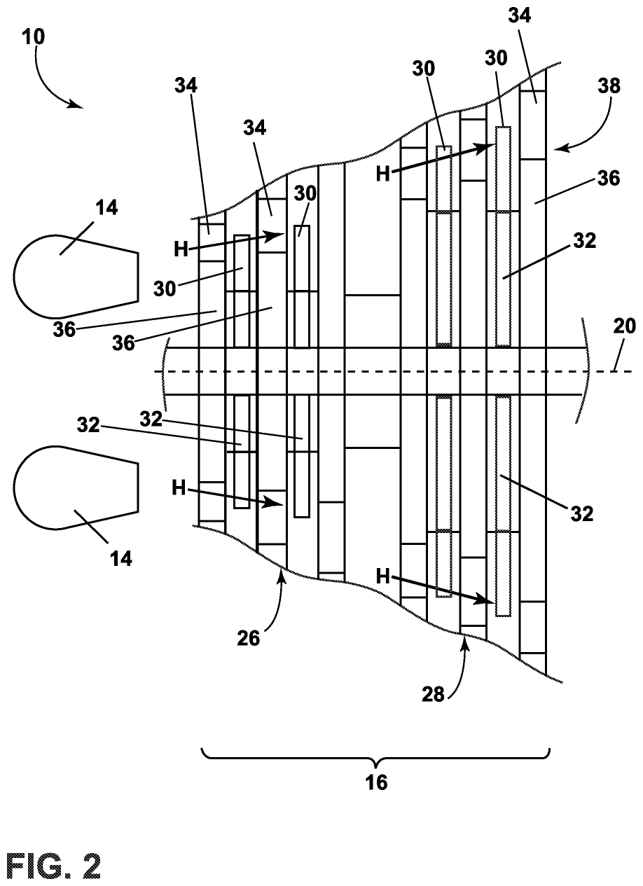

Turning to FIG. 2, a portion of the turbine section 16 is schematically illustrated. The turbine section 16 includes a set of blades 30 circumferentially mounted to corresponding disks 32. Any number of individual blades 30 can be mounted to each disk 32. While shown schematically in FIG. 2, it should be understood that the turbine engine 10 can be a single stage turbine, or can include additional stages as shown.

Stationary vanes 34 are mounted to a stator ring 36 located radially exterior of each of the disks 32. A nozzle 38 is defined by circumferentially-adjacent pairs of vanes 34. Any number of nozzles 38 can be provided on the stator ring 36. In one exemplary configuration, each disk 32 includes at least sixty (60) blades 30, including from sixty to seventy (60-70) blades 30, or up to sixty-four (64) blades 30, in non-limiting examples. Each stator ring 36 includes at least 38 nozzles 38, including f thirty-eight to fifty (38-50) nozzles 38, or up to forty-two (42) nozzles 38, in non-limiting examples. During operation of the turbine engine 10, a flow of hot gas (denoted “H”) exits the combustor 14 and enters the turbine section 16.

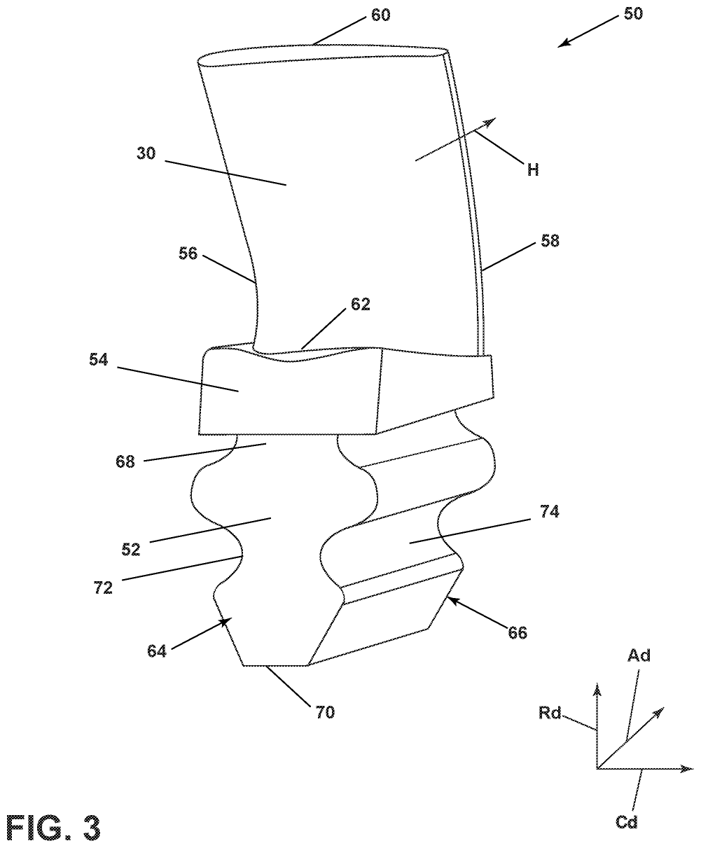

FIG. 3 shows a schematic view of a blade assembly 50 including one blade 30, that can be used in the turbine engine 10 (FIG. 1) and within the set of blades 30 (FIG. 2). The blade assembly 50 further includes a dovetail 52 and a platform 54, with the platform 54 connecting the blade 30 to the dovetail 52. The blade 30 includes a leading edge 56 and a trailing edge 58 defining a chord-wise direction therebetween, and includes a tip 60 and a root 62 defining a span-wise direction therebetween. The blade assembly 50 can include a forward face 64 adjacent the leading edge 56 and an aft face 66 adjacent the trailing edge 58. The dovetail 52 further includes a shank 68, which connects the dovetail 52 to the platform 54. The dovetail 52 includes a bottom surface 70 which can extend between the forward face 64 and the aft face 66, and includes a first side 72 and a second side 74 spacing the forward face 64 from the aft face 66.

The dovetail 52 mounts to the disk 32 (FIG. 2) in order to rotatably drive the blade 30. Materials used to form the dovetail 52 or related structures include, but are not limited to, steel, refractory metals such as titanium, or superalloys based on nickel, cobalt, or iron, ceramic matrix composites, or combinations thereof. The structures can be formed by a variety of methods, including additive manufacturing, casting, electroforming, or direct metal laser melting, in non-limiting examples.

Additionally, a set of axes are included in FIG. 3 to aid in the reader's orientation of the blade assembly 50 within the turbine engine 10 of FIG. 1. An axial direction denoted “Ad” extends axially in a direction extending between forward and aft, which can be arranged parallel to the engine centerline 20 of FIG. 1. A radial direction denoted “Rd” extends perpendicular to the axial direction Ad. The radial direction Rd defines a radius extending radially from the engine centerline 20. A circumferential direction Cd extends perpendicular to the radial direction Rd, and can be defined tangent to a circle defined by a radius defined along the radial direction Rd. Additionally, a flow of hot gas H passes along the blade 30. The flow of hot gas H extends generally in the axial direction Ad, from forward to aft, while the local directionality can vary being driven or turned by blades or vanes.

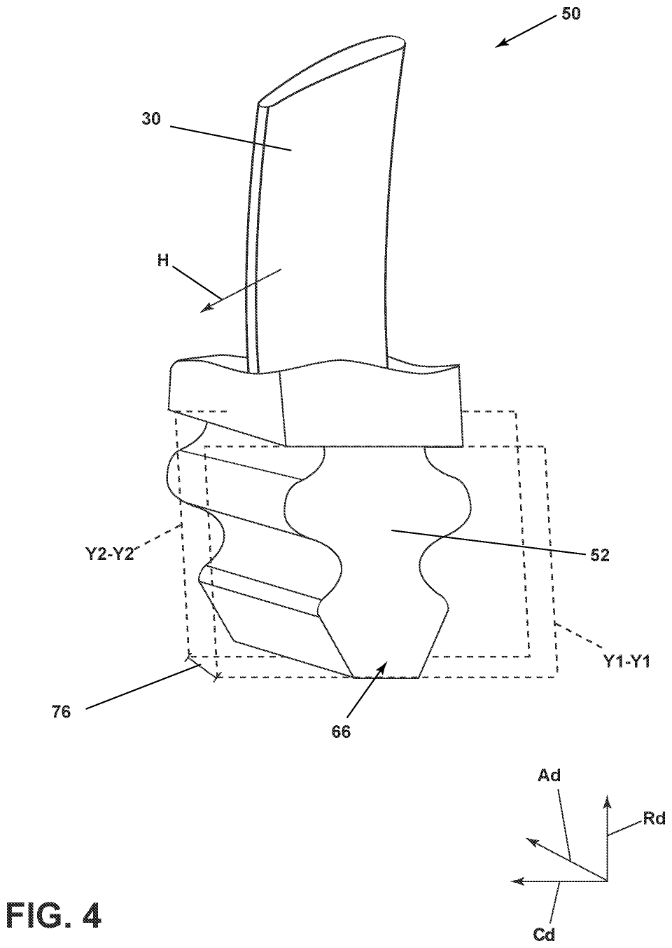

Referring to FIG. 4, showing the aft face 66 of the blade assembly 50, the dovetail 52 can define a plane Y1-Y1 defined along the aft face 66 of the dovetail 52. A second plane Y2-Y2 can be positioned forward of the Y1-Y1 plane by a spacing distance 76, arranged parallel to the Y1-Y1 plane. In one non-limiting example, the spacing distance can be 0.275 inches, while any suitable spacing distance is contemplated.

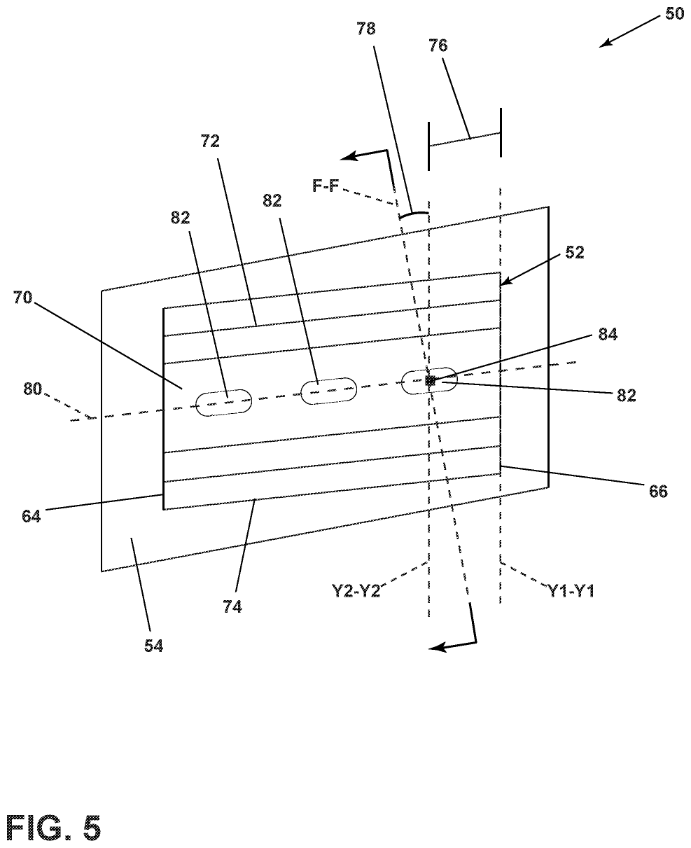

Referring now to FIG. 5, showing a bottom view of the blade assembly 50 and the bottom surface 70 of the dovetail 52, an offset plane F-F can be aligned with, yet offset from the Y2-Y2 plane, arranged at an offset angle 78. The spacing distance 76 as 0.275 inches can align with an interior inlet passage 82, which defines the position of the offset plane F-F. The offset angle 78 can be 10-degrees, in one non-limiting example. The alignment of the offset plane F-F with the Y2-Y2 plane can be based on an opening axis 80 which can be defined extending between the forward face 64 and the aft face 66 of the dovetail 52. In one example, the opening axis 80 centrally aligns with one or more inlet passage 82 at the bottom surface 70. In another non-limiting example, the opening axis 80 can be arranged parallel to the first and second sides 72, 74 of the dovetail 52, and centrally positioned between the first and second sides 72, 74.

The offset angle 78 can be defined by rotating the Y2-Y2 plane along a line 84 (depicted as a point 84 in FIG. 5, as the line extends into and out of the page) defined where the Y2-Y2 plane intersects the offset plane F-F. The line 84 can be arranged where the opening axis 80 intersects the Y2-Y2 plane, and the F-F axis can be defined by rotating the Y2-Y2 plane about the line 84. In one example, the line 84 can be arranged parallel to the radial direction Rd (FIG. 4), while an angular deviation therefrom is contemplated.

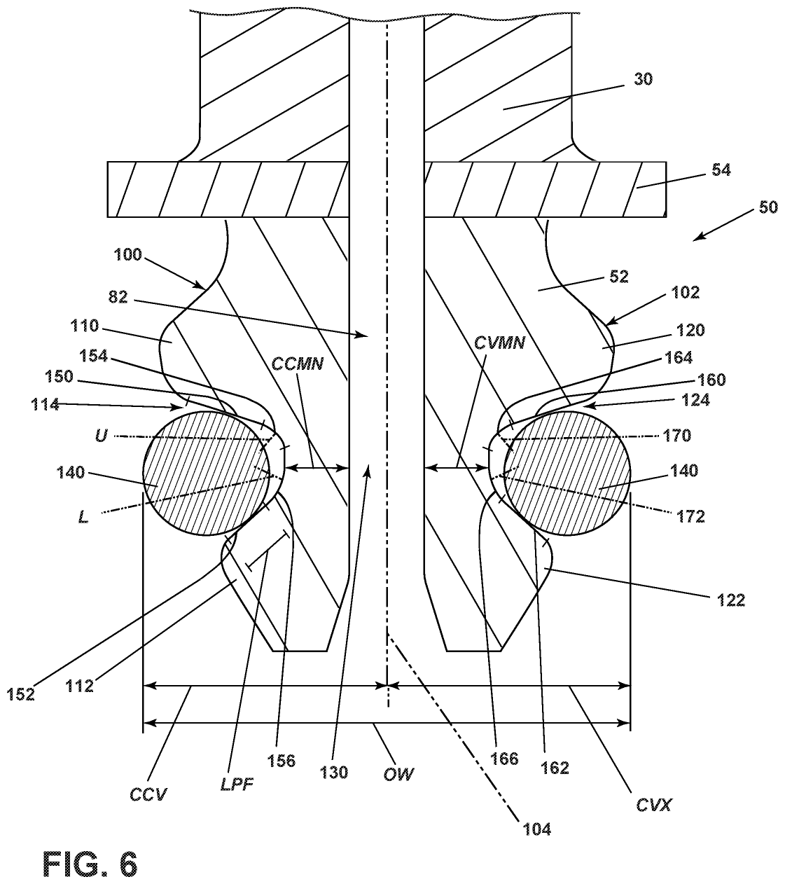

FIG. 6 is a schematic cross-sectional view of the blade assembly 50 showing the section that corresponds to the offset plane F-F of FIG. 5 and looking in a direction from aft to forward, to better detail the geometry of the dovetail 52. The at least one inlet passage 82 effectively separates the dovetail 52 into a first portion 100 and a second portion 102. The at least one inlet passage 82 further defines a passage axis 104, positioned in the axial center of the at least one inlet passage 82, for example. While only one inlet passage 82 is visible in the sectional view shown, it should be appreciated that the at least one inlet passage 82 includes a set of inlet passages, including one or more, such as three as shown in FIG. 5. It is contemplated that the first portion 100 and the second portion 102 can be symmetric, relative to the passage axis 104, while non-symmetric embodiments are contemplated.

The first portion 100 includes an upper lobe 110 and a lower lobe 112, defining an intervening recess 114 therebetween. Similarly, the second portion 102 includes an upper lobe 120 and a lower lobe 122, defining an intervening recess 124 therebetween. The intervening recesses 114, 124 collectively define a neck 130 with the at least one inlet passage 82.

A gage pin 140 is shown provided within each of the intervening recesses 114, 124. The gage pin 140 is used for measuring tolerances during or after manufacture, and is removed for installation of the blade 30 and dovetail 52 within an engine. In one non-limiting example, the gage pin 140 is a 0.165 in gage pin (approximately 4.191 millimeters). The gage pin 140 is positioned to contact the dovetail 52 at the intervening recesses 114, 124, and ultimately removed for installation and use within an engine structure.

A first planar surface 152 at least partially defines the lower lobe 112 and the intervening recess 114, and a second planar surface 150 is at least partially defined by the upper lobe 110 and the intervening recess 114. A first curved surface 156 extends into the intervening recess 114 from the first planar surface 152 and a second curved surface 154 extends between the second planar surface 150 and the first curved surface 156. The first curved surface 156 positions tangent to the first planar surface 152. The first curved surface 156 positions tangent to the second curved surface 154, and the second curved surface 154 positions tangent to the second planar surface 150. The first curved surface 156 has a constant radius of curvature that defines a first radius length L and the second curved surface 154 has a constant radius of curvature that defines a second radius length U. It is contemplated that the first radius length U is the same or different from the first radius length L. It is further contemplated that there may be no second curved surface 154 (i.e., no U), and the first curved surface 156 extends between the first planar surface 152 and the second planar surface 150, arranged tangent to both the first and second planar surfaces 152, 150 at the junction of the first planar surface 152 and the first curved surface 156, and the junction of the second planar surface 150 and the first curved surface 156.

The intervening recess 124 along the second portion 102 is at least partially defined by a third planar surface 160 and a fourth planar surface 162. The third planar surface 160 at least partially defines the upper lobe 120, and the fourth planar surface 162 at least partially defines the lower lobe 122.

A third curved surface 164 extends into the intervening recess 124 from the third planar surface 160 and a fourth curved surface 166 extends between the third curved surface 164 and the fourth planar surface 162. The third curved surface 164 is arranged tangent to the third planar surface 160. The third curved surface 164 is arranged tangent to the fourth curved surface 166, and the fourth curved surface 166 is tangent to the fourth planar surface 162. The third curved surface 164 defines a third radius 170 having a third radius of curvature, and the fourth curved surface 166 define a fourth radius 172 having a fourth radius of curvature. It is contemplated that there is no third curved surface 164, and the fourth curved surface 166 extends between the third planar surface 160 and the fourth planar surface 166, being arranged tangent to the third and fourth planar surfaces 160, 162.

Optionally, it is contemplated that there are additional planar surfaces provided between the curved surfaces in additional non-limiting examples. More specifically, a planar surface is provided between one or more of the first and second curved surfaces 156, 154, or the third and fourth curved surfaces 164, 166. Such a planar surface is arranged parallel to the passage axis 104, for example, while angled arrangements are contemplated.

It should be appreciated that the planar surfaces are shown in cross section, and that the planar description relates to the cross-sectional view shown in FIG. 3. Therefore, it should be understood that this description is written toward a cross-section of a three-dimensional geometry.

A first width CCV′ is defined as the distance between the passage axis 104 and the furthest extent of the gage pin 140 provided within the intervening recess 114. A second width CVX is defined as the distance between the passage axis 104 and the furthest extent of the gage pin 140 provided within the intervening recess 124. A total width OW is defined as the combined width of the first width CCV and the second width CVX. The widths CCV, CVX, OW are defined in the circumferential direction Cd (FIG. 4), and/or is perpendicular to the passage axis 104, in non-limiting examples.

A first recess width CCMN is defined as the minimum distance between the intervening recess 114 and the at least one inlet passage 82. A second recess width CVMN is defined as the minimum distance between the intervening recess 124 and the at least one inlet passage 82. The geometry for the dovetail 52 is arranged such that the first and second recess widths CCMN, CVMN are defined parallel to one or more of the first second, and total widths CCV, CVX, OW, in non-limiting examples.

The first width CCV and the first recess width CCMN can be arranged or identified as near, adjacent to, or arranged at or complementary to a concave portion of the blade 30, while the second width CVX and the second recess width CVMN can be arranged or identified as near, adjacent to, or arranged complementary to a convex portion of the blade 30.

During manufacture, particular geometries at tight tolerances for the dovetail 52 are required. Therefore, a balance must be maintained between increasing durability and stress resistance at the neck 130, while maintaining operational minimum requirements, as well as capability of use within current engine systems.

Finding a workable solution to the neck durability problem, as well as related blade-rotor interface balanced with overall system durability, weight, size, and/or cost, involves finding the balance between the length and size of the upper and lower lobes 110, 112, the thickness of the intervening recess 114 at the neck 130, as well as the local radiuses of curvature extending between the lengths defined along those upper and lower lobes 110, 112. This is a labor and time-intensive process due to the process being iterative and involving the selection of various dimensions, there are numerous variations which are within the performance requirements for the dovetail 52 described herein. Put another way, the dovetail 52, and geometries thereof, were selected accordingly for various dovetail configurations before a range of particular geometries was found that satisfies all design requirements, e.g., aerodynamic performance, stress mitigation, rigidity, durability, thermal stresses, engine efficiency, sizing constraints within current engine systems, or the like.

As alluded to earlier, standard practice has been to use increased size or stronger material, which can combat local stresses. However, such increased size and stronger materials can lead to increased costs, system weight, and overall space occupied by the dovetail. The inventors have found it beneficial to vary the geometries defining the dovetail in order to mitigate or reduce local stresses, while remaining within the constraints of existing engine systems. This is a labor and time intensive process because the process is iterative and involves the selection of particular dimensions designed for operating within current engine systems, running tests to determine the stresses associated with particular iterations, then evaluating whether these stresses are maintained during operating cycles, thereby necessitating re-design of the dovetail to further reduce or decrease local stresses, or moving stress paths by varying local geometries. That is, the dovetail is selected according to a size, type, etc. before a dovetail is found that satisfies all three key requirements: sizing to existing engine systems, acceptable stress levels, and acceptable stress load paths. It would be desirable to have a limited or narrowed range of embodiments defined for an engine architecture satisfying mission requirements, such requirements including optimal blade operation as determined by mounting the blade to the disk at the dovetail.

Table 1 below illustrates geometries for the dovetail 52, with each example including differing values that yielded workable solutions to the problem as described above, and with reference to FIG. 6.

TABLE 1

| Parameter: | Element: | Example 1 | Example 2 | Example 3 | Example 4 | Units |
|---|---|---|---|---|---|---|
| L | First Curved | 0.04 | 0.104 | 0.079 | 0.098 | in |
| | Surface (156) | | | | | |
| CVX | Second Width | 0.333 | 0.334 | 0.327 | 0.325 | in |
| | (CVX) | | | | | |
| CVMN | Second Recess | 0.05 | 0.14 | 0.121 | 0.112 | in |
| | Width (CVMN) | | | | | |
| LPF | First Planar | 0.721 | 0.746 | 0.795 | 0.742 | in |
| | Surface (152) | | | | | |
| EGT | Engine Exhaust | 980 | 920 | 923.2 | 928 | ° C. |
| | Gas Temperature | | | | | |
| RPM | Engine | 14000 | 16000 | 15795 | 15535 | rpm |
| | Rotational Speed | | | | | |

The inventors discovered, unexpectedly, during the course of their engine design, that a relationship exists between the geometry of the dovetail at the lobes and recesses used to couple the blade to the disk, which results in the desired reduction and mitigation of local dovetail stresses, which, until this discovery, could only be accomplished by the previous time-consuming and iterative process. Furthermore, such reduction and mitigation can be realized while fitting within size and weight constraints and accounting for the fitting requirements of a mating rotor design of an existing engine system. Specifically, there was discovered a relationship between the radius of curvature or the first radius length/defined by the first curved surface 156, and the second recess width CVMN. The curvature of the first curved surface 156 defining the first radius length L is used to vary the required minimum thicknesses at the neck 130 that is able to bear anticipated engine operational conditions. Reducing the required minimum thickness at the neck 130 reduces overall weight, without sacrificing resiliency, when utilizing the first radius length L defined by the first curved surface 156 as described herein.

It was also discovered that a relationship between the first radius length L defined by the first curved surface 156, and the dovetail contour stress or stress concentration, as well as its particular load path. More specifically, the geometry of the first planar surface 152 is used to control the stress concentration or contour within the dovetail 52, which mitigates such stress by varying the first planar surface 152. While stress concentrations and crack formation or propagation locations can be roughly predicted from models, this relationship was not discoverable from one of these models. Rather, it was the exhaustive testing undertaken for components, weighting the benefits and penalties to not just mechanical strength but other factors as well (as explained herein). The first radius length L affects the local strength and stiffness of the upper lobe 110, which relates to local stress concentration, path and contour. Varying the geometry of the first curved surface 156 varies the position of local stress concentration, load path, or contour, which can be adapted to a structurally stronger area and/or to areas better-suited to bear those stresses through such variation.

It was also discovered that there is a relationship between the first planar surface 152 and the second recess width CVMN. The first planar surface 152, and the length thereof, determines the face length or area borne by the lower lobe 112 against the disk 32 (FIG. 2) during engine operation. A greater or larger length or area for the first planar surface 152 provides a lower overall tangency point, which increases or improves durability against critical crush stress, as well as optimizes stress tangency points and improves overall load path. The distance defined for the second recess width CVMN sets the tangential location of the forms relative to the casting datums when casting the dovetail 52 or related assembly. The tangential location can be set relative to the dovetail centerline, and the second width CVX and second recess width CVMN sets the tangential location of the blade centroid relative to that centerline. Setting this tangential location of the blade centroid (blade center of mass) balances centrifugal and aerodynamic loading for the blade 30 and dovetail 52. Balancing or controlling the loading reduces the dovetail bending moments and stresses at the disk 32, which improves overall disk lifetime as well as dovetail durability, while mitigating local stresses at the dovetail 52.

There is also a relationship between the total width OW, as defined partially by the aft width CVX, and the minimum thicknesses at the neck 130 required to bear engine stresses. A reduction beyond such a minimum thickness can lead to local stress increases that are unable to be borne by the dovetail 52. The inventors' practice takes these minimums into consideration, and ensure that ranges are within these tolerances and able to be borne by the dovetail 52.

Such relationships narrow the vast range of possible dovetail designs down to a range providing working solutions with a desired degree of thermal and operational efficiency for specific engine configurations. After conducting numerous cycle tests, it was found that modifying dovetail geometries in accordance with these relationships, within the particular described ranges, results in a highly useful and desirable dovetail geometry with respect to stress reduction, determining load path, defining stress contour concentration, critical crush stress and tangency points, determining blade centroid location and improving overall balance, with reduced related loading on one or both of the disk and dovetail, increased durability and cycle life for the blade for particular engine configurations, as well as maintaining appropriate sizing and tolerances for use in existing engine or disk systems. The relationship discovered, unexpected findings, and benefits described above are expressed by the inventors in terms of EQ1 and EQ2. The ranges associated with EQ1 and EQ2 were unexpectedly found to identify an improved dovetail design, better suited for a particular engine operating environment and taking into account the constraints imposed on dovetail design for an airfoil used in such a system.

A first Expression, referred to herein as “EQ1”, is defined as Expression (1):

$$E Q 1 = {( \frac{LPF}{\text{.75} in} )}^{4} * {( \frac{CVX}{\text{.31} in} )}^{\frac{1}{4}} * ( \frac{{( \frac{N 2}{15000 RPM} )}^{\frac{1}{2}}}{{( \frac{E G T}{950 ° C .} )}^{\frac{1}{2}}} ) \qquad ( 1 )$$

LPF represents the length of the first planar surface 152 and CVX represents the aft width CVX. N2 represents the rotational speed of the turbine engine 10 of FIG. 1 during operation, measured in units of revolutions per minute. In one example, N2 can be the rotational speed of the particular dovetail for which the LPF and CVX values are determined, where rotational speed can otherwise differ based upon position in the turbine engine 10 (such as among the HP and LP turbines 26, 28, as defined by a gearbox). EGT represents the maximum operating temperature for the turbine engine 10 measured at a particular location within the turbine engine 10. Such a particular location can be at the exit of the high-pressure turbine 26 (FIG. 1), for example. Turbine engines are typically certified prior to operation, and it is contemplated that publicly available certification documentation can be utilized to determine the engine EGT values and/or the engine position where the EGT is determined.

Furthermore, it should be appreciated that the EGT for the engine changes over time due to engine degradation. Many factors can contribute to engine degradation, such as degradation of surface components or changes in airfoil clearances, dirt or other contaminants, the opening of seals and clearances over time, erosion of engine components or other physical deterioration in non-limiting examples. Such deterioration over time can result in changes for the values of EGT over time. Therefore, it is within the scope of this description that the Expressions defined herein can account for changes in EGT over time or component lifecycle, and one can account for such changes during design of the dovetail 52. For example, as deterioration increases, local temperatures increase as well. On a pristine engine, the EGT may begin at 900° C. and increase toward 950° C. over time. It is contemplated that the Expressions herein can account for deterioration of the engine over time, and may be varied in relation to degradation of the engine over time. A designer must contemplate a wide range of operating conditions, including a range of EGT temperatures, in order to ensure that the design meets design requirements across such a range. It is within the scope of this description to contemplate incorporation of varying EGT values over time into the Expressions. Similarly, while an engine is turning on or operating at idle, there may be a period where the engine is colder than 900° C. Considering these relatively colder temperatures or related rotational speeds (RPM) are within the scope of this disclosure. The Expressions provided herein can be representative of the EGT for an engine in pristine condition, for example. Expression 1, referred to as “EQ1”, can vary from 0.775 to 1.35.

A second Expression, referred to herein as “EQ2”, is defined as Expression (2):

$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{{950}^{∘} C .} )} ) \qquad ( 2 )$$

The First radius length L represents the length of the radius defined by the radius of curvature of the first curved surface 156, and CVMN represents the minimum aft width for the neck 130, defined as the second recess width CVMN. N2 represents the rotational speed of the turbine engine 10 of FIG. 1 during operation, measured in units of revolutions per minute. In one example, N2 can be the rotational speed of the particular dovetail for which the first radius length L and second recess width CVMN values are determined, where rotational speed can otherwise differ based upon position in the turbine engine 10 (such as among the HP and LP turbines 26, 28, as defined by a gearbox). EGT represents the operational temperature of the engine. In one example, EGT can be measured as the operational temperature of the engine local to the dovetail 52, or local to the blade 30 extending from the dovetail 52. In another example, EGT can be measured as the maximum engine operational temperature, such as being measured at the combustor 14 of FIG. 1. Expression 2, herein “EQ2” can vary from 0.013 to 5.84. Table 2 provided below provides values for Expression 1 and Expression 2 for the Examples 1-4 taken from Table 1.

TABLE 2

| Parameter: | Example 1 | Example 2 | Example 3 | Example 4 | Units |
|---|---|---|---|---|---|
| Expression 1 | 0.827 | 1.046 | 1.331 | 0.999 | n/a |
| Expression 2 | 0.137 | 5.836 | 1.05 | 3.88 | n/a |

It was found that the range of values for Expression 1 and Expression 2 correlate to a high performing dovetail with peak performance utilizing the factors discussed herein. While narrowing these multiple factors to a region of possibilities saves time, money, and resources, the largest benefit is at the system level, where improved dovetails enable improved system performance. A narrowed design range for Expression 1 of between 0.775 and 1.35, and Expression 2 of between 0.013 and 5.84 result in the dovetail 52 with structural integrity, while remaining within desired tolerances and capable of use in existing engine systems.

Benefits are realized when the manufactured component including the dovetail 52 have a geometry where both Expression 1 can vary from 0.775 to 1.35, and Expression 2 can vary from 0.013 to 5.84. Such benefits include a reduction in stress on the dovetail 52 at the neck 130, which reduces a time between a need for replacement parts and increase the lifetime of the dovetail 52. This provides for increased durability for the dovetail 52, which decreases required maintenance and costs, while increasing overall engine reliability.

Further still, the benefits included herein provide for a dovetail 52 that fits within existing engines. For example, the values for Expression 1 and Expression 2 as provided herein take existing engines into consideration, permitting replacement of current dovetails with replacement dovetails (or new dovetails) having the parameters of the dovetail 52 described herein. Such consideration provides for replacing and improving current engine systems without requiring the creation of new disks capable of mounting to the dovetail 52. This provides for improving current engine durability without increasing costs to prepare new engines or further adapt existing engines.

Table 3 below illustrates non-limiting configurations for the dovetail 52, showing two minimum and maximum value ranges for the dovetail 52. A first range is labelled as a “First Min.” representing a minimum value and a “First Max.” representing a maximum value. As is appreciable, the Second Range includes a broader range than that of the First Range.

TABLE 3

| | | | | |
|---|---|---|---|---|
| Parameter: | Engine Element: | First Min: | First Max: | Units: |

First Range

| | | | | |
|---|---|---|---|---|
| L | First Curved Surface (156) | 0.079 | 0.081 | Length (in) |
| CVX | Aft width (CVX) | 0.3209 | 0.3284 | Length (in) |
| CVMN | Second Recess Width (CVMN) | 0.0775 | 0.1145 | Length (in) |
| LPF | First Planar Surface (152) | 0.767 | 0.773 | Length (in) |

Second Range

| | | | | |
|---|---|---|---|---|
| L | First Curved Surface (156) | 0.04 | 0.104 | Length (in) |
| CVX | Aft width (CVX) | 0.315 | 0.335 | Length (in) |
| CVMN | Second Recess Width (CVMN) | 0.050 | 0.140 | Length (in) |
| LPF | First Planar Surface (152) | 0.710 | 0.795 | Length (in) |

Table 4 below illustrates a range for values for the EGT and the RPM parameters for use in Expression 1 and Expression 2.

TABLE 4

| Parameter: | Minimum | Maximum | Units |
|---|---|---|---|
| EGT | 920 | 980 | Degrees Celsius (° C.) |
| RPM | 14000 | 16000 | Revolutions per |
| | | | Minute (RPM) |

Additional benefits associated with the dovetail 52 described herein include a quick assessment of design parameters in terms of dovetail size and geometry, engine operational conditions, and blade and vane numbers for engine design and particular dovetail or blade design. Narrowing these multiple factors to a region of possibilities saves time, money, and resources. The dovetail 52 described herein enables the development and production of high-performance turbine engines and dovetails across multiple performance metrics within a given set of constraints.

To the extent one or more structures provided herein can be known in the art, it should be appreciated that the present disclosure can include combinations of structures not previously known to combine, at least for reasons based in part on conflicting benefits versus losses, desired modes of operation, or other forms of teaching away in the art.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the disclosure are provided by the subject matter of the following clauses:
A turbine engine, comprising: an engine core extending along an engine centerline and including a compressor section, a combustor generating hot combustion gases at an exhaust gas temperature (EGT), and a turbine section in serial flow arrangement; a disk provided within the engine core and rotatable about the engine centerline; and a blade comprising a dovetail mounted to the disk and rotatable by the disk at a rotation speed (N2), and an inlet passage extending through the dovetail and into the blade defining a passage axis, wherein the dovetail comprises; a first portion including a first upper lobe, a first lower lobe, and a first intervening recess between the first upper lobe and the first lower lobe, a first curved surface at least partially defining the first lower lobe and the first intervening recess, a first planar surface at least partially defining the first lower lobe and the first intervening recess, a second portion including a second upper lobe, a second lower lobe, and a second intervening recess between the second upper lobe and second lower lobe, a first radius length (L) defined as a radius of a curvature of the first curved surface, and a first length (LPF) defined as a minimum length defined by the first planar surface, an aft width (CVX) defined as a minimum length between the passage axis and the furthest extent of a gage pin provided within the second intervening recess, and a recess width (CVMN) defined as a minimum length between the inlet passage and the second intervening recess, wherein the exhaust gas temperature (EGT), the rotational speed of the engine (N2), the first length (LPF), and the aft width (CVX), define a first value (EQ1) by the following expression:

$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) \qquad ( 3 )$$

wherein the exhaust gas temperature (EGT), the rotation speed (N2), the first radius length (L), and the recess width (CVMN), define a second value (EQ2) by the following expression:

$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) \qquad ( 4 )$$

wherein the first value (EQ1) is between 0.775 and 1.35, and the second value (EQ2) is between 0.013 and 5.84.

The turbine engine of any preceding clause further comprising a second curved surface extending from the first curved surface and arranged tangent to the first curved surface.

The turbine engine of any preceding clause further comprising a second planar surface extending from the second curved surface opposite of the first curved surface, and wherein the second planar surface is arranged tangent to the second curved surface.

The turbine engine of any preceding clause wherein a second radius length (U) defined by a radius of curvature for the second curved surface is different from the first radius length (L).

The turbine engine of any preceding clause wherein the first portion and the second portion are symmetric about the passage axis.

The turbine engine of any preceding clause wherein the gage pin is a 0.165 in gage pin.

The turbine engine of any preceding clause wherein the first length (LPF) is between 0.710 in and 0.795 in (18.034 mm and 20.193 mm) and the aft width (CVX) is between 0.315 in and 0.335 in (8.001 mm and 8.509 mm).

The turbine engine of any preceding clause wherein the first radius length (L) is between 0.04 and 0.104 in (1.016 mm and 2.642 mm) and the recess width (CVMN) is between 0.050 in and 0.140 in (1.27 mm and 3.556 mm).

The turbine engine of any preceding clause wherein the rotation speed (N2) is between 14000 rpm and 16000 rpm and the exhaust gas temperature (EGT) is between 920° C. and 960° C.

A turbine engine generates hot combustion gases at an exhaust gas temperature (EGT), includes a disk provided within the engine core and rotatable about the engine centerline, and includes a dovetail for mounting a blade to the disk and rotatable by the disk at a rotation speed (N2), the dovetail having an inlet passage defining a passage axis, the dovetail comprising: a first portion including a first upper lobe, a first lower lobe, and a first intervening recess between the first upper lobe and the first lower lobe, a first curved surface at least partially defining the first lower lobe and the first intervening recess, a first planar surface at least partially defining the first lower lobe and the first intervening recess, a second portion including a second upper lobe, a second lower lobe, and a second intervening recess between the second upper lobe and second aft lower lobe, a first radius length (L) defined as a radius of a curvature of the first curved surface, and a first length (LPF) defined as a minimum length defined by the first planar surface, an aft width (CVX) defined as a minimum length between the passage axis and the furthest extent of a gage pin provided within the second intervening recess, and a recess width (CVMN) defined as a minimum length between the inlet passage and the second intervening recess, wherein the exhaust gas temperature (EGT), the rotational speed of the engine (N2), the first length (LPF), and the aft width (CVX), define a first value (EQ1) by the following expression:

$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) \qquad ( 5 )$$

wherein the exhaust gas temperature (EGT), the rotation speed (N2), the first radius length (L), and the recess width (CVMN), define a second value (EQ2) by the following expression:

$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) \qquad ( 6 )$$

wherein the first value (EQ1) is between 0.775 and 1.35, and the second value (EQ2) is between 0.013 and 5.84.

The dovetail of any preceding clause wherein the dovetail includes a forward face and an aft face, the dovetail defines a first plane along the aft face, and the dovetail defines a second plane parallel to and spaced from the first plane.

The dovetail of any preceding clause wherein the second plane is aligned with the inlet passage.

The dovetail of any preceding clause further comprising an offset plane offset from the second plane by an offset angle, and wherein the offset plane defines a section through the dovetail, wherein the first portion, the first curved surface, the planar surface, and the second portion are defined along the offset plane.

The dovetail of any preceding clause wherein the offset angle is 10-degrees.

The dovetail of any preceding clause wherein the first plane is spaced from the second plane by 0.275 inches (6.985 mm).

A turbine engine comprising: an engine core extending along an engine centerline and including a compressor section, a combustor generating hot combustion gases at an exhaust gas temperature (EGT), and a turbine section in serial flow arrangement; a disk provided within the engine core and rotatable about the engine centerline; and a blade rotatable by the disk; a dovetail, coupling the blade to the disk and rotatable by the disk at a rotation speed (N2), the dovetail having an inlet passage extending through the dovetail and into the blade defining a passage axis, wherein the dovetail comprises; a first portion including a first upper lobe, a first lower lobe, and a first intervening recess between the first upper lobe and the first lower lobe, a first curved surface at least partially defining the first lower lobe and the first intervening recess, a first planar surface at least partially defining the first lower lobe and the first intervening recess, a second portion including a second upper lobe, a second lower lobe, and a second intervening recess between the second upper lobe and second aft lower lobe, a first radius length (L) defined as a radius of a curvature of the first curved surface, and a first length (LPF) defined as a minimum length defined by the first planar surface, an aft width (CVX) defined as a minimum length between the passage axis and the furthest extent of a gage pin provided within the second intervening recess, and a recess width (CVMN) defined as a minimum length between the inlet passage and the second intervening recess, wherein the exhaust gas temperature (EGT), the rotational speed of the engine (N2), the first length (LPF), and the aft width (CVX), define a first value (EQ1) by the following expression:

$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) \qquad ( 7 )$$

wherein the exhaust gas temperature (EGT), the rotation speed (N2), the first radius length (L), and the recess width (CVMN), define a second value (EQ2) by the following expression:

$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) \qquad ( 8 )$$

wherein the first value (EQ1) is between 0.775 and 1.35, and the second value (EQ2) is between 0.013 and 5.84.

The turbine engine of any preceding clause wherein the first length (LPF) is between 0.710 in and 0.795 in (18.034 mm and 20.193 mm) and the aft width (CVX) is between 0.315 in and 0.335 in (8.001 mm and 8.509 mm).

The turbine engine of any preceding clause wherein the first radius length (L) is between 0.04 and 0.104 in (1.016 mm and 2.642 mm) and the recess width (CVMN) is between 0.050 in and 0.140 in (1.27 mm and 3.556 mm).

The turbine engine of any preceding clause wherein the rotation speed (N2) is between 14000 rpm and 16000 rpm and the exhaust gas temperature (EGT) is between 920° C. and 960° C.

The turbine engine of any preceding clause further comprising a second curved surface extending between the first curved surface and first planar surface, wherein the second curved surface is arranged tangent to the first curved surface and the first planar surface.

A method of operating a turbine engine having an engine core extending along an engine centerline and including a compressor section, a combustor generating hot combustion gases at an exhaust gas temperature (EGT), and a turbine section in serial flow arrangement, the method comprising: rotating a blade with a disk about the engine centerline at a rotation speed (N2), the blade coupled to the disk by a dovetail, wherein the dovetail comprises; an inlet passage defining a passage axis; a first portion including a first upper lobe, a first lower lobe, and a first intervening recess between the first upper lobe and the first lower lobe; a first curved surface at least partially defining the first lower lobe and the first intervening recess; a first planar surface at least partially defining the first lower lobe and the first intervening recess; a second portion including a second upper lobe, a second lower lobe, and a second intervening recess between the second upper lobe and second lower lobe; a first radius length (L) defined as a radius of a curvature of the first curved surface; a first length (LPF) defined as a minimum length defined by the first planar surface; an aft width (CVX) defined as a minimum length between the passage axis and the furthest extent of a gage pin provided within the second intervening recess; a recess width (CVMN) defined as a minimum length between the inlet passage and the second intervening recess; wherein the exhaust gas temperature (EGT), the rotational speed of the engine (N2), the first length (LPF), and the aft width (CVX), define a first value (EQ1) by the following expression:

$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) \qquad ( 9 )$$

wherein the exhaust gas temperature (EGT), the rotation speed (N2), the first radius length (L), and the recess width (CVMN), define a second value (EQ2) by the following expression:

$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) \qquad ( 10 )$$

wherein the first value (EQ1) is between 0.775 and 1.35, and the second value (EQ2) is between 0.013 and 5.84.

The method of any preceding clause wherein the first portion and the second portion are symmetric about the passage axis.

The method of any preceding clause wherein the gage pin is a 0.165 in gage pin.

The method of any preceding clause wherein the first length (LPF) is between 0.710 in and 0.795 in (18.034 mm and 20.193 mm) and the aft width (CVX) is between 0.315 in and 0.335 in (8.001 mm and 8.509 mm).

The method of any preceding clause wherein the first radius length (L) is between 0.04 and 0.104 in (1.016 mm and 2.642 mm) and the recess width (CVMN) is between 0.050 in and 0.140 in (1.27 mm and 3.556 mm).

The method of any preceding clause wherein the rotation speed (N2) is between 14000 rpm and 16000 rpm and the exhaust gas temperature (EGT) is between 920° C. and 960° C.

1. A turbine engine, comprising:
an engine core extending along an engine centerline and including a compressor section, a combustor configured to generate hot combustion gases at an exhaust gas temperature (EGT), and a turbine section in serial flow arrangement;
a blade comprising a dovetail rotatable about the engine centerline at a rotation speed (N2), and an inlet passage extending through the dovetail and into the blade defining a passage axis, wherein the dovetail comprises;
a first portion including a first upper lobe, a first lower lobe, and a first intervening recess between the first upper lobe and the first lower lobe,
a first curved surface at least partially defining the first lower lobe and the first intervening recess,
a first planar surface at least partially defining the first lower lobe and the first intervening recess,
a second portion including a second upper lobe, a second lower lobe, and a second intervening recess between the second upper lobe and second lower lobe,
a first radius length (L) defined as a radius of a curvature of the first curved surface, and
a first length (LPF) defined as a minimum length defined by the first planar surface,
an aft width (CVX) defined as a minimum length between the passage axis and a furthest extent of a gage pin provided within the second intervening recess, and
a recess width (CVMN) defined as a minimum length between the inlet passage and the second intervening recess,
wherein the exhaust gas temperature (EGT), the rotational speed of the engine (N2), the first length (LPF), and the aft width (CVX), define a first value (EQ1) by the following expression:
$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) ,$$
wherein the exhaust gas temperature (EGT), the rotation speed (N2), the first radius length (L), and the recess width (CVMN), define a second value (EQ2) by the following expression:
$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) ,$$
and
wherein the first value (EQ1) is between 0.827 and 1.331, and the second value (EQ2) is between 0.137 and 5.836.

2. The turbine engine of claim 1 further comprising a second curved surface extending from the first curved surface and wherein the first curved surface is arranged tangent to the first planar surface.

3. The turbine engine of claim 2 further comprising a second planar surface extending from the second curved surface opposite of the first curved surface, and wherein the second planar surface is arranged tangent to the second curved surface.

4. The turbine engine of claim 2 wherein a second radius length (U) defined by a radius of curvature for the second curved surface is different from the first radius length (L).

5. The turbine engine of claim 1 wherein the first portion and the second portion are symmetric about the passage axis.

6. The turbine engine of claim 1 wherein the gage pin is a 0.165 in gage pin.

7. The turbine engine of claim 1 wherein the first length (LPF) is between 0.721 in and 0.795 in (18.313 mm and 20.193 mm) and the aft width (CVX) is between 0.325 in and 0.334 in (8.255 mm and 8.484 mm).

8. The turbine engine of claim 1 wherein the first radius length (L) is between 0.04 and 0.104 in (1.016 mm and 2.642 mm) and the recess width (CVMN) is between 0.050 in and 0.140 in (1.27 mm and 3.556 mm).

9. The turbine engine of claim 1 wherein the rotation speed (N2) is between 14000 rpm and 16000 rpm and the exhaust gas temperature (EGT) is between 920° C. and 980° C.

10. A turbine engine configured to generate hot combustion gases at an exhaust gas temperature (EGT), the turbine engine including an engine core extending along an engine centerline, and including an airfoil with a dovetail configured to rotate about the engine centerline a rotation speed (N2), the dovetail having an inlet passage defining a passage axis, the dovetail comprising:
a first portion including a first upper lobe, a first lower lobe, and a first intervening recess between the first upper lobe and the first lower lobe,
a first curved surface at least partially defining the first lower lobe and the first intervening recess,
a first planar surface at least partially defining the first lower lobe and the first intervening recess,
a second portion including a second upper lobe, a second lower lobe, and a second intervening recess between the second upper lobe and second aft lower lobe,
a first radius length (L) defined as a radius of a curvature of the first curved surface, and
a first length (LPF) defined as a minimum length defined by the first planar surface,
an aft width (CVX) defined as a minimum length between the passage axis and a furthest extent of a gage pin provided within the second intervening recess, and
a recess width (CVMN) defined as a minimum length between the inlet passage and the second intervening recess,
wherein the exhaust gas temperature (EGT), the rotational speed of the engine (N2), the first length (LPF), and the aft width (CVX), define a first value (EQ1) by the following expression:
$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) ,$$
wherein the exhaust gas temperature (EGT), the rotation speed (N2), the first radius length (L), and the recess width (CVMN), define a second value (EQ2) by the following expression:
$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{EGT}{95 {0}^{∘} C .} )} ) ,$$
and
wherein the first value (EQ1) is between 0.827 and 1.331, and the second value (EQ2) is between 0.137 and 5.836.

11. The dovetail of claim 10 wherein the dovetail includes a forward face and an aft face, the dovetail defines a first plane along the aft face, and the dovetail defines a second plane parallel to and spaced from the first plane.

12. The dovetail of claim 11 wherein the second plane is aligned with the inlet passage.

13. The dovetail of claim 12 further comprising an offset plane offset from the second plane by an offset angle, and wherein the offset plane defines a section through the dovetail, wherein the first portion, the first curved surface, the first planar surface, and the second portion are defined along the offset plane.

14. The dovetail of claim 13 wherein the offset angle is 10-degrees.

15. The dovetail of claim 13 wherein the first plane is spaced from the second plane by 0.275 inches (6.985 mm).

16. A turbine engine comprising:
an engine core extending along an engine centerline and including a compressor section, a combustor configured to generate hot combustion gases at an exhaust gas temperature (EGT), and a turbine section in serial flow arrangement;
a blade configured to rotate about the engine centerline at a rotation speed (N2), the blade including a dovetail having an inlet passage extending through the dovetail and into the blade defining a passage axis, wherein the dovetail comprises:
a first portion including a first upper lobe, a first lower lobe, and a first intervening recess between the first upper lobe and the first lower lobe,
a first curved surface at least partially defining the first lower lobe and the first intervening recess,
a first planar surface at least partially defining the first lower lobe and the first intervening recess,
a second portion including a second upper lobe, a second lower lobe, and a second intervening recess between the second upper lobe and second aft lower lobe,
a first radius length (L) defined as a radius of a curvature of the first curved surface, and
a first length (LPF) defined as a minimum length defined by the first planar surface,
an aft width (CVX) defined as a minimum length between the passage axis and a furthest extent of a gage pin provided within the second intervening recess, and
a recess width (CVMN) defined as a minimum length between the inlet passage and the second intervening recess,
wherein the exhaust gas temperature (EGT), the rotational speed of the engine (N2), the first length (LPF), and the aft width (CVX), define a first value (EQ1) by the following expression:
$$EQ 1 = {( \frac{LPF}{\text{.75} in} )}^{4} * {( \frac{CVX}{\text{.31} in} )}^{\frac{1}{4}} * ( \frac{{( \frac{{N}_{2}}{15000 RPM} )}^{\frac{1}{2}}}{{( \frac{EGT}{95 {0}^{∘} C .} )}^{\frac{1}{2}}} ) ,$$
wherein the exhaust gas temperature (EGT), the rotation speed (N2), the first radius length (L), and the recess width (CVMN), define a second value (EQ2) by the following expression:
$$EQ 2 = {( \frac{L}{0.08 in} )}^{6} * {( \frac{CVMN}{0.08 in} )}^{\frac{1}{6}} * ( \frac{( \frac{{N}_{2}}{15000 RPM} )}{( \frac{E G T}{95 {0}^{∘} C .} )} ) ,$$
and
wherein the first value (EQ1) is between 0.827 and 1.331, and the second value (EQ2) is between 0.137 and 5.836.

17. The turbine engine of claim 16 wherein the first length (LPF) is between 0.721 in and 0.795 in (18.313 mm and 20.193 mm) and the aft width (CVX) is between 0.325 in and 0.334 in (8.255 mm and 8.484 mm).

18. The turbine engine of claim 16 wherein the first radius length (L) is between 0.04 and 0.104 in (1.016 mm and 2.642 mm) and the recess width (CVMN) is between 0.050 in and 0.140 in (1.27 mm and 3.556 mm).

19. The turbine engine of claim 16 wherein the rotation speed (N2) is between 14000 rpm and 16000 rpm and the exhaust gas temperature (EGT) is between 920° C. and 980° C.

20. The turbine engine of claim 16 further comprising a second curved surface extending between the first curved surface and the first planar surface, wherein the second curved surface is arranged tangent to the first curved surface and the first planar surface.
